(19) United States
(12) Patent Application Publication
(10) Pub. No.: US 2006/0245611 A1
(43) Pub. Date: Nov. 2, 2006

(54) Hearing aid with visual indicator

(75) Inventors: Ivan H.H. Jørgensen, Dk-2900 Hellerup (DK); Christian C. Bürger, Smørum (DK); Traci Schmidtke Flynn, Smørum (DK)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: OTICON A/S

(21) Appl. No.: 10/558,691

(22) PCT Filed: May 13, 2004
(86) PCT No.: PCT/DK04/00339

§ 371 Date: May 2, 2006

(30) Foreign Application Priority Data
Jun. 4, 2003 (DK) PA200300834

(51) Int. Cl. H04R 25/00

(52) U.S. Cl. 381/323

(57) ABSTRACT

The invention comprises a hearing aid, which has a casing containing a signal receiving part for receiving an audio signal, an audio transducer for providing an audio signal to the user, a signal transmission path between the signal receiving part and the audio transducer, whereby a battery is provided for powering the signal receiving part, the signal path and the audio transducer, and where further means are provided for assessing the function of the hearing aid and for generating an electrical indication signal which indicates the function of the hearing aid and where further means are provided for intermittently generating a power signal in response to the electrical indication signal and where means are provided for converting the power signal into a light signal, such that the light signal is visible from outside the hearing aid.

### BACKGROUND OF THE INVENTION

Hear aids are also used by young children and mentally impaired people, and for patients in this category it is a special problem that the patient may not be capable of reporting to the surroundings whether the hearing aid is functioning properly or not. It has been reported that on frequent occasions young children in kindergartens have worn their hearing aids, but the nursing staff has failed to turn them on. On such an occasion the child is worse off with the hearing aid than without, as the ear plug effectively blocks all sounds off, and any residual hearing which the child may have is of no use. From WO 2002098503 A1 it is known to provide detection and indication of proper operation of a transmitter of an auditory prosthesis. The auditory prosthesis can be a hearing aid or an implanted device. Electromagnetic emissions of a transmission part of the auditory prosthesis are detected, and an indicator such as a LED is provided on the transmitter of the prosthesis which indicates whether or not electromagnetic emissions of the transmitter have been detected. It is however not commercially attractive to produce a normal hearing aid with LED elements, as the power which LED elements consume in ordinary use will cause an excessive battery consumption by the hearing aid.

### SUMMARY OF THE INVENTION

There is thus a need for a hearing aid, which is commercially attractive and which in a clear and unequivocal way can display to the surroundings whether it is functioning properly or not.

This is provided by a hearing aid, which has a casing containing a signal receiving part for receiving an audio signal, an audio transducer for providing an audio signal to the user, a signal transmission path between the signal receiving part and the audio transducer, whereby a battery is provided for powering the signal receiving part, the signal path and the audio transducer, and where further means are provided for assessing the function of the hearing aid and for generating an electrical indication signal which indicates the function of the hearing aid and where further-means are provide for intermittently generating a power signal in response to the electrical indication signal and where means are provided for converting the power signal into a light signal, such that the light signal is visible from outside the hearing aid.

Short or long term intervals may be used when the intermittent power signal is generated If short term intervals are used, the light would appear to be turned on constantly, provided the hearing aid is functioning, but the glow would be at a low level. If longer intervals are used, the light would appear to be blinking, but the glow would be with a higher intensity. In any event the battery consumption would be dramatically reduced through the intermitting drive of the light emitting element. Thereby a hearing aid is provided, which gives nurses, teachers, parents or other people dealing with hearing impaired patients a possibility to easily detect whether the hearing aid is turned on and functioning.

In an embodiment of the invention the means for converting the electrical power signal into a light signal is a LED or light emitting diode. Such diodes run at very low power, which enables their use in hearing aids where the available power is very limited. Any low power light emitting element could however be used for this purpose.

In an embodiment of the invention the LED power signal is generated inside the hearing aid and a LED element is mounted in the casing of the hearing aid and the LED power signal is presented to the LED element in order for the light to be visible from outside the casing.

Having the LED element in the casing of the hearing aid is an advantage as a compact hearing aid may be made and no connection points to external elements are necessary in order to have the LED function.

In an embodiment the electrical signal indicating the function of the hearing aid is transmitted to an external accessory which comprises a LED element and where further the LED power signal is intermittently generated in the external element.

Through this arrangement it becomes possible to add an accessory like a usual audio shoe to the hearing aid and gain contact with the signal indicating the function of the hearing aid.-The signal is then used to switch on the LED in the accessory. This allows people to visually perceive whether or not the hearing aid of the patient is functioning or not. The hearing aid will be exactly like any ordinary hearing aid and the additions necessary to provide the indication-signal will be minimal, and the added production costs will be very small. Thus it will be commercially interesting to provide this option in a hearing aid. The hearing users who needs the LED indication will have to purchase an accessory which provides the visual indication means, but as the need especially for young children for this indication is strong, there is likely to be willingness to pay for the added value. Further for this group of hearing aid users the added size of the hearing aid is of minor importance. Off cause the accessory with the visual indication element may contain other electronic parts as well, allowing reception of FM, RF or other wireless or wired audio or alarm signals, which are then in the usual way conveyed to the hearing aid.

In an embodiment of the invention the indication signal is controlled by the signal leading to the audio transducer. In this way it can be observed whether the audio transducer actually is powered by the hearing aid. Any malfunction, which is caused in the signal receiving part or the signal path or by lack of battery power, will thus be visible as this would cause the LED to be turned off, even if sounds are present, which should turn it on. Also a malfunction of the type, which causes the hearing aid to constantly produce a loud noise, would be detectable by other people. In this case the LED would be turned on, also in cases where no sound is present where the LED is supposed to be turned off.

In an embodiment of the invention, the hearing aid is powered by a zink-air battery, and the LED is powered from the battery through a voltage doubler. Zink-air batteries are the most commonly used in present day hearing aids, but they have too low voltage to light up the LED elements available at present. A voltage doubler is often used in hearing aids for powering parts of the signal processing elements used herein, and it is quite simple to provide the doubled voltage also to the LED element in the accessory.

In an embodiment the LED element is a multi colour LED. Hereby it becomes possible to use different colours to indicate different statuses of the hearing aid Various programs could be indicated by each their colour or progressive lack of battery power could be indicated through shifts of colour.

In an embodiment the LED is caused to blink with varying frequency in dependency of a functional parameter of the hearing aid. This could preferably be the battery status, but it could also be according to the quality of a wireless signal received by the hearing aid or by the acessory.

### BRIEF DESCRIPTION OF THE DRAWINGS

FIG. 1 is a schematic representation of a possible way of implementing the invention.

### DESCRIPTION OF A PREFERRED EMBODIMENT

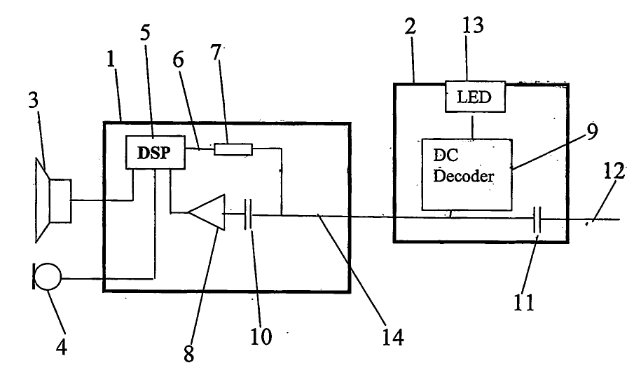

In FIG. 1 the hearing aid 1 has a DSP unit 5, which is connected to an audio receiving transducer 4 and an audio transmitting transducer 3. Further the DSP unit is connected through an amplifier 8 and a DC de-coupling capacitor 10 to a DAI shoe 2 or similar input device. The audio input device receives an external signal at input part 12, preferably a DAI input signal, and this is transmitted though DC de-coupling capacitor 11 to the hearing aid 1 through input line 14.

The DSP unit 5 further has a terminal 6 which is provided with a signal, which indicates the functional status of the hearing aid. In the present example this signal is fed through resistor 7 and presented at the DAI or other audio input line 14 as a DC level. In the DAI or similar accessory this is sensed by a DC decoder element 9 and the DC level of the input line is used to control the function of a LED element 13.

Different DC levels in the line 14 can be used to either shift between different colours or the shift between different blinking frequency of the LED element. An intermittent drive signal may be produced in the accessory based on the DC level of the line 14. It would be advantageous to mute the apparatis whenever a shift in the DC level occurs, as this might otherwise produce noise in the hearing aid.

A dedicated line to operate the LED element is of cause also an option, and may be preferred in various situations. Especially when an intermittent drive signal is fed from the hearing aid to the LED in the accessory, this is preferred as this will not disturb the possible audio transmission from the accessory. The dedicated line could comprise a signal line and a power line, whereby the signal line controls the function of the LED element and the power line supplies the power to drive the LED. A simple power line is also possible, whereby the power thereof is switched by means placed in the hearing aid.

In the above example the LED is placed inside an accessory, but the LED element may also be placed inside the casing of the hearing aid.

The DSP unit may through various self-diagnostic procedures determine whether or not the hearing aid is functioning and provide the signal for controlling the LED accordingly.

1. Hearing aid, which has a casing containing a signal receiving part for receiving an audio signal, an audio transducer for providing an audio signal to the user, a signal transmission path between the signal receiving part and the audio transducer, whereby a battery is provided for powering the signal receiving part, the signal path and the audio transducer, and where further means are provided for assessing the function of the hearing aid and for generating an electrical indication signal which indicates the function of the hearing aid and where further means are provide for intermittently generating a power signal in response to the electrical indication signal and where means are provided for converting the power signal into a light signal, such that the light signal is visible from outside the hearing aid.

2. Hearing aid as claimed in claim 1, whereby the means for converting the electrical power signal into a light signal is a LED or light emitting diode.

3. Hearing aid as claimed in claim 2, whereby the LED power signal is generated inside the hearing aid and a LED element is mounted in the casing of the hearing aid and the LED power signal is presented to the LED element in order for the light to be visible from outside the casing.

4. Hearing aid as claimed in claim 2, whereby the electrical signal indicating the function of the hearing aid is transmitted to an external accessory which comprises a LED element and where further the LED power signal is intermittently generated in the external element.

5. Hearing aid as claimed in claim 2, whereby the indication signal is controlled by the signal leading to the audio transducer.

6. Hearing aid as claimed in claim 4, whereby the hearing aid is powered by a zink-air battery, and the LED is powered from the battery through a voltage doubler.

7. Hearing aid as claimed in claim whereby the voltage doubler is placed in the accessory.

8. Hearing aid as claimed in claim 2, whereby the LED element is a multi colour LED.

9. Hearing aid as claimed in claim 7, whereby the LED is caused to blink with varying frequency in dependency of a parameter of the hearing aid which relates to the function of the hearing aid.
